(19) United States
(12) Patent Application Publication
(10) Pub. No.: US 2014/0210296 A1
(43) Pub. Date: Jul. 31, 2014

(54) ROTOR FOR PERMANENT MAGNET TYPE MOTOR, METHOD OF MANUFACTURING ROTOR FOR PERMANENT MAGNET TYPE MOTOR, AND PERMANENT MAGNET TYPE MOTOR

(71) Applicant: SANYO DENKI CO., LTD., Tokyo (JP)

(72) Inventor: Toshihito Miyashita, Tokyo (JP)

(73) Assignee: SANYO DENKI CO., LTD., Tokyo (JP)

(21) Appl. No.: 14/167,054

(22) Filed: Jan. 29, 2014

(30) Foreign Application Priority Data
Jan. 31, 2013 (JP) 2013-017209

(51) Int. Cl. H02K 1/27; H02K 15/03

(52) U.S. Cl. CPC H02K 1/27; H02K 15/03
USPC 310/156.53; 29/598

(57) ABSTRACT

A rotor for a permanent magnet type motor has rotor core blocks in a multistage in an axial direction in which permanent magnets of a plurality of magnetic poles are incorporated, and has a stage skew structure in which the rotor core blocks of each stage are integrally formed so as to be shifted from each other in a rotational direction. The rotor core blocks of each stage have a flux barrier portion for blocking a short circuit magnetic flux between the magnetic poles, between the magnetic poles of the permanent magnet. A skew angle is set so that the flux barrier portions of the magnetic poles between the adjacent stages at least partially overlap each other in the rotor core blocks of different stages.

### BACKGROUND

1. Technical Field

The present invention relates to a rotor for a permanent magnet type motor with an improved rotor skew structure of the permanent magnet type motor in which permanent magnets are incorporated into a rotor core, a method of manufacturing the rotor for the permanent magnet type motor, and a permanent magnet type motor.

2. Description of Related Arts

In motors using the permanent magnets, cogging torque is generated. The cogging torque is a rotary pulsation of the rotor generated by an interaction between a permeance distribution caused by winding slots of a stator and a magnetic flux distribution generated from the permanent magnet.

Conventionally, a skew structure has been adopted as a means for reducing the cogging torque. For example, in a rotor of a surface permanent magnet type motor (an SPM motor) formed by bonding the permanent magnet onto a surface of a rotary shaft, a technique of reducing the cogging torque by providing the permanent magnets in a plurality of stages to form a multistage skew structure has been suggested (see JP 61-17876 Y (FIG. 1)).

Furthermore, in the stator core, a technique of reducing the cogging torque by the skew structure has also been suggested (for example, see JP 63-140635 A (FIG. 1)).

Additionally, in a rotor for an interior permanent magnet type motor (an IPM motor) in which the permanent magnets are incorporated and embedded into the interior of the rotor core, a technique of providing a step skew structure by a permanent magnet of a tetrapolar configuration in two stages has been suggested (for example, see JP 2000-308287 A (FIGS. 1 to 4)).

According to JP 2000-308287 A (FIGS. 1 to 4), since a short circuit magnetic path in an axial direction is generated by providing the skew structure in the rotor, a non-magnetic material is interposed between the permanent magnet of the first stage and the permanent magnet of the second stage to reduce the inter-stage short circuit magnetic flux, thereby suppressing a decrease in torque.

Incidentally, in the technique of JP 2000-308287 A (FIGS. 1 to 4), the non-magnetic material is interposed between the permanent magnet of the first stage and the permanent magnet of the second stage. However, since a thrust action area decreases by interposing the non-magnetic material between the stages of the permanent magnet, eventually, the torque decreases.

In the permanent magnet type motor, the skew structure is an effective means for reduction of the cogging torque.

However, the short circuit magnetic flux in the axial direction caused by the skew structure becomes a factor of the torque decrease. In some cases, due to the occurrence of the short circuit magnetic flux in the axial direction, the effect of reducing the cogging torque is lowered. Accordingly, in the permanent magnet type motor, the development of skew structure that does not generate the short circuit magnetic flux in the axial direction is requested.

### SUMMARY

The invention has been made in view of the above circumstances, and an object thereof is to provide a rotor for a permanent magnet type motor capable of more effectively reducing the cogging torque by suppressing the torque decrease due to the occurrence of short circuit magnetic flux between the stages in the multistage rotor skew structure, a method of manufacturing the rotor for the permanent magnet type motor, and a permanent magnet type motor.

A rotor for a permanent magnet type motor according to the invention for achieving the above-mentioned object has rotor core blocks in a multistage in the axial direction in which permanent magnets of a plurality of magnetic poles are incorporated. The rotor core blocks of each stage are integrally formed so as to be shifted from each other in the circumferential direction, and have a multistage skew structure.

Between the magnetic poles of the permanent magnet, the rotor core blocks of each stage have a flux barrier portion for blocking the short circuit magnetic flux between the magnetic poles.

In the rotor core blocks of different stages, a skew angle is set so that the flux barrier portions of the magnetic poles between the adjacent stages at least partially overlap each other.

The rotor for the permanent magnet type motor according to the invention has a multistage skew structure, and since the flux barrier portions of the magnetic poles between the adjacent stages at least partially overlap each other in the rotor core blocks of different stages, it is possible to block the occurrence of short circuit magnetic flux between the stages.

Therefore, it is possible to suppress the torque decrease due to the occurrence of short circuit magnetic flux in the multistage skew structure, and it is possible to more effectively reduce the cogging torque.

### BRIEF DESCRIPTION OF THE DRAWINGS

FIG. 1 is a schematic view of an overall configuration of a permanent magnet type motor according to a first embodiment;

FIG. 2 is a schematic view of a cross-sectional shape of a rotor core;

FIG. 3 is a schematic view of a state in which the permanent magnets are incorporated into the rotor core;

FIG. 4 is a schematic perspective view of the rotor of a case in which the skew structure is configured in two stages;

FIG. 5 is an enlarged view of main parts when FIG. 4 is viewed from the axial direction;

FIG. 6 is a perspective view of a rotor in a case in which a three-stage skew structure is provided in the same direction in a permanent magnet type rotor according to a second embodiment;

FIG. 7 is an enlarged view of main parts when FIG. 6 is viewed from the axial direction;

FIG. 8 is a perspective view of the rotor in a case in which a three-stage skew structure is provided and skew directions are alternately inverted, in a permanent magnet type rotor according to a third embodiment;

FIG. 9 is an enlarged view of main parts when FIG. 8 is viewed from the axial direction;

FIG. 10 is a schematic view of a rotor core having skew positioning holes in a permanent magnet type rotor according to a fourth embodiment;

FIG. 11 is an exploded perspective view of the rotor having the skew positioning holes;

FIG. 12 is a perspective view of the rotor in a case in which a three-stage skew structure is provided and skew directions are alternately inverted, in the permanent magnet type rotor according to the fourth embodiment; and

FIG. 13 is an enlarged view of main parts when FIG. 12 is viewed from the axial direction.

### DETAILED DESCRIPTION

Hereinafter, a permanent magnet type motor according to first to fourth embodiments will be described with reference to the drawings.

The rotors for the permanent magnet type motor according to the first to fourth embodiments have a multistage rotor skew structure, and the flux barrier portions of the magnetic poles between the adjacent stages at least partially overlap each other in the rotor core blocks of different stages. Therefore, according to the rotor, it is possible to suppress the short circuit magnetic flux between the stages, and it is possible to achieve a permanent magnet type motor of a multistage rotor skew structure having excellent effect of reducing the cogging torque.

### First Embodiment

### Configuration of Permanent Magnet Type Motor

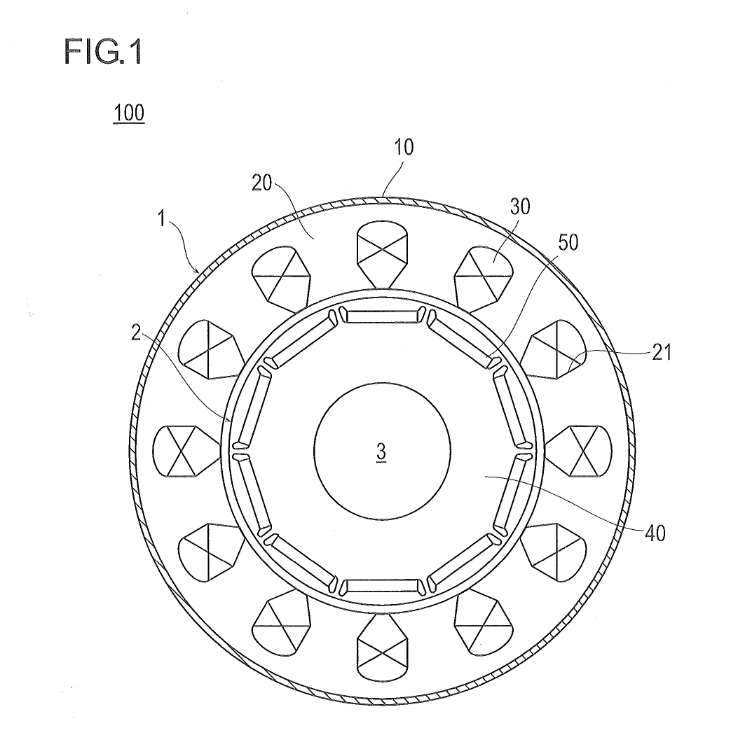

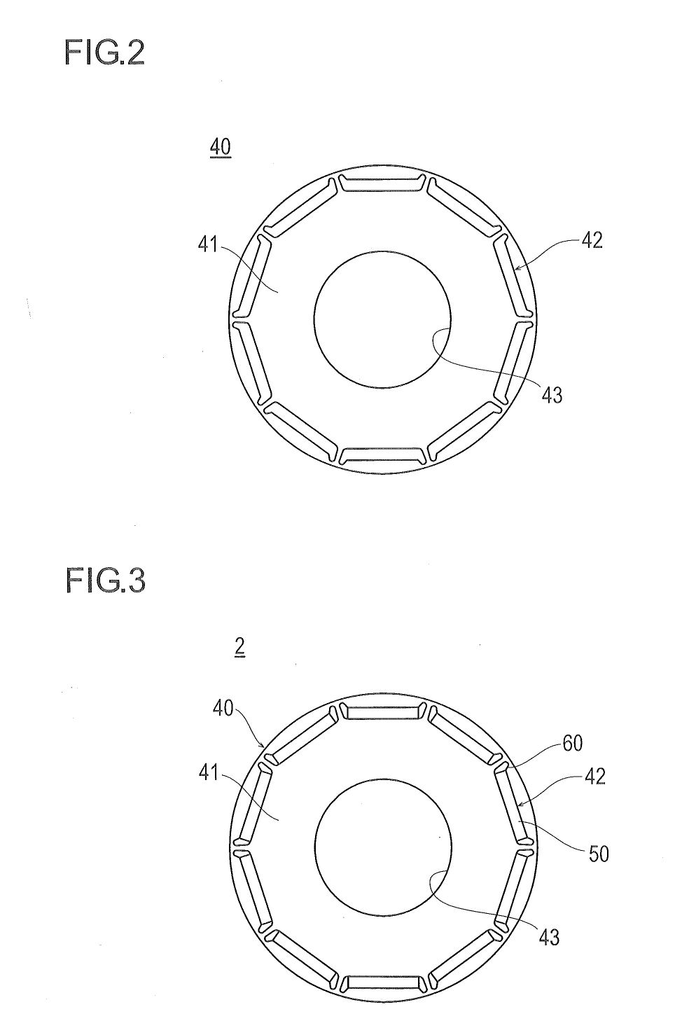

First, a configuration of the permanent magnet type motor according to a first embodiment will be described with reference to FIGS. 1 to 5. FIG. 1 is a schematic view of the overall configuration of the permanent magnet type motor according to the first embodiment. FIG. 2 is a schematic view of the cross-sectional shape of the rotor core. FIG. 3 is a schematic view of a state in which the permanent magnets are incorporated into the rotor core.

As the permanent magnet type motor of the first embodiment, for example, there is an interior permanent magnet motor (an IPM motor) in which a plurality of permanent magnets is incorporated into the interior of the rotor core. A permanent magnet type motor 100 illustrated in FIG. 1 is an IPM motor of 10 poles and 12 slots, and includes a stator 1 and a rotor 2.

As illustrated in FIG. 1, the stator 1 includes a yoke 10, a stator core 20, and a coil 30.

The yoke 10 is a cylindrical metal member. The yoke 10 has a function of maximizing effects of using the magnetic flux of a permanent magnet 50 to be described later by closing the line of magnetic force. Furthermore, the yoke 10 also has a function of preventing the peripheral devices of the motor 100 from being influenced by a magnetic field due to the leakage magnetic flux.

As the materials of the yoke 10, for example, soft magnetic materials such as silicon steel plates are used, but are not limited to the exemplary materials.

The stator core 20 is a cylindrical metallic member provided along an inner surface of the yoke 10. A plurality of slots 21 as spaces for accommodating the coils 30 are dividedly formed radially so as to face the rotor 2 on the inner peripheral side of the stator core 20.

As the materials of the stator core 20, for example, the soft magnetic materials such as silicon steel plates are used in the same manner as the yoke 10, but are not limited to the exemplary materials.

The coils 30 are disposed in the slots 21. The numbers of the slots 21 and the coils 30 correspond to each other. In the present embodiment, twelve slots 21 and coils 30 are disposed, but the numbers of the slots 21 and the coils 30 are not limited.

The rotor 2 is provided around the shaft 3, and has a rotor core 40 and a permanent magnet 50. The shaft 3 serves as a center of rotation of the rotor 2.

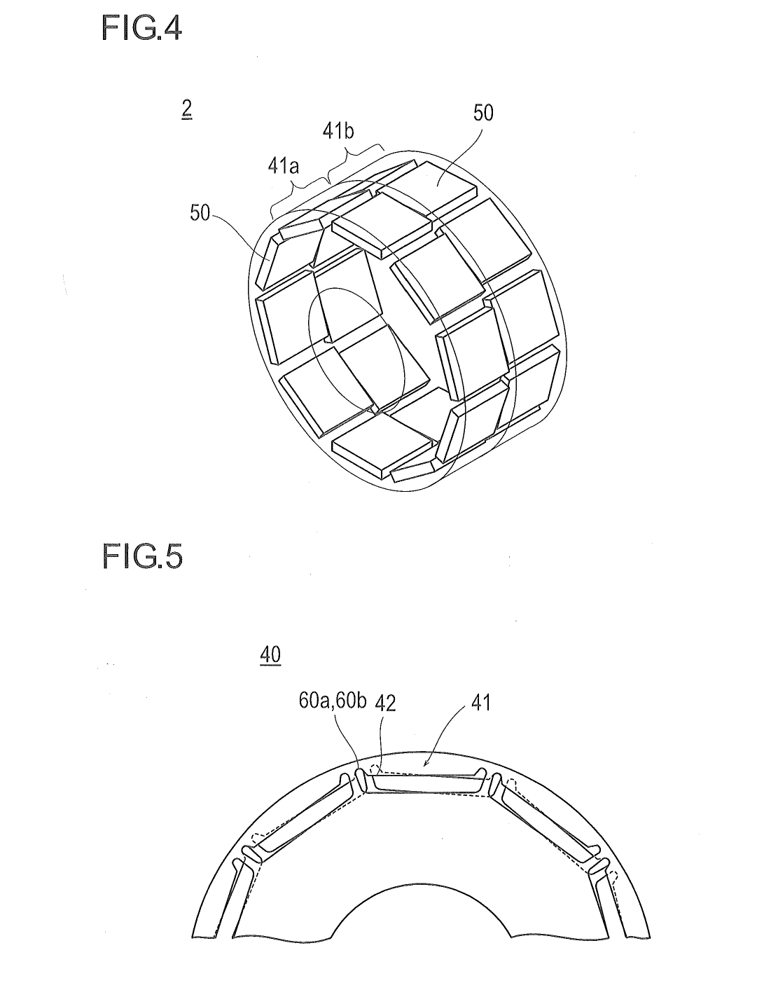

The rotor core 40 has a plurality of rotor core blocks 41 in a multistage in the axial direction, and has a stage skew structure in which the rotor core blocks 41 of each stage are integrally formed so as to be circumferentially shifted. The rotor core 40 of the present embodiment includes rotor core blocks 41 of the two-stage (see FIG. 4).

The rotor core blocks 41 are cylindrical metallic members disposed around the shaft 3. The rotor core blocks 41 may be configured as a rotor core stack obtained by stacking a plurality of core sheets or may be formed by a single cylindrical metal member.

As illustrated in FIG. 2, a shaft fitting hole 43 for inserting and fixing the shaft 3 is formed in a central portion of the rotor core block 41.

A plurality of magnet insertion holes 42 for incorporating the permanent magnets are formed near the outer peripheral portion of the rotor core block 41. The plurality of magnet insertion holes 42 is uniformly disposed along the circumferential direction of the rotor core block 41. For example, the magnet insertion holes 42 of the present embodiment have a shape such as adding an oval to both rectangular ends so as to be inclined, but are not limited to the illustrated shape.

As the materials of the rotor core block 41, for example, the soft magnetic materials such as silicon steel plates are used, but are not limited to the exemplary materials.

As illustrated in FIGS. 1 and 2, a plurality of the permanent magnets 50 are incorporated into the rotor core block 41. The permanent magnet 50 has a rectangular plate shape. The plurality of the permanent magnets 50 is uniformly disposed along the circumferential direction of the rotor core block 41. For example, the permanent magnets 50 are disposed in such a manner that N and S are alternately magnetized in the circumferential direction of the rotor core 40, but are not limited to the illustrated magnetization arrangement. In the present embodiment, the permanent magnets 50 of 10 poles are disposed, but the number of the permanent magnets 50 is not limited.

As the permanent magnet 50, for example, rare earth magnets such as neodymium magnets are adopted, but are not limited to the exemplary materials.

A flux barrier portion 60 is provided between the magnetic poles of the permanent magnet 50 (see FIG. 3). The flux barrier portion 60 has a function of blocking the magnetic flux shorted between the adjacent permanent magnets. The flux barrier portions 60 of the present embodiment are dividedly formed as space portions on both sides of the permanent magnet 50 incorporated into the magnet insertion hole 42.

The flux barrier portions 60 are not limited to the space portions as in the present embodiment, a non-magnetic material such as an adhesive and resin used for bonding the magnet may be filled in the flux barrier portions 60, and in this case, there is no influence on the blocking function of the short circuit magnetic flux.

Next, the stage skew structure in the first embodiment will be described with reference to FIGS. 4 and 5. FIG. 4 is a perspective view of the rotor in a case in which the skew structure is configured in two stages. In FIG. 4, the rotor core is illustrated in a translucent manner so that the state of the skew structure is easily understood. FIG. 5 is an enlarged view of main parts when FIG. 4 is viewed from the axial direction. In FIG. 5, the front rotor core is illustrated in a translucent manner for clarity and the permanent magnet is not illustrated.

As illustrated in FIG. 4, the rotor 2 has rotor core blocks 41a and 41b formed by incorporating the permanent magnets 50 of the plurality of magnetic poles in two stages in the axial direction, and has a stage skew structure in which the rotor core blocks 41a and 41b of each stage are integrally formed in a state of being shifted from each other in the circumferential direction.

The respective cylindrical rotor core blocks 41a and 41b are shifted from each other in a circumferential direction, but are formed in the same configuration. Therefore, as illustrated in FIGS. 4 and 5, the magnet insertion holes 40 and the permanent magnets 50 incorporated into the magnet insertion holes 40 are disposed in a state of being shifted from each other in the direction of rotation.

The skew angle is set so that the flux barrier portions 60a and 60b between the adjacent magnetic poles at least partially overlap each other in the rotor core blocks 41a and 41b of different stages. The flux barrier portions 60a and 60b which overlap each other at least partially match each other in the axial direction through the stage.

In the rotor 2 of the present embodiment, as illustrated in FIG. 5, the cross-sectional shape of the flux barrier portions 60a and 60b which overlap each other has substantially an oval, and outer peripheral shapes thereof substantially match each other. Since the flux barrier portions 60, 60 substantially match each other in the axial direction through the stage, it is possible to block the short circuit magnetic flux between the stages flowing in the axial direction.

### Action of Permanent Magnet Type Motor

Next, the operation of the permanent magnet type motor 100 according to the first embodiment will be described with reference to FIGS. 1 to 5.

As illustrated in FIG. 1, the rotor 2 of the permanent magnet type motor 100 according to the present embodiment is configured so that the plurality of permanent magnets 50 are incorporated into the interior of the rotor core stack 40. The plurality of permanent magnets 50 is disposed so that N and S are alternately magnetized in the circumferential direction.

On the other hand, the stator 1 is provided to surround the rotor 2, and has a plurality of coils 30 radially arranged in the circumferential direction.

That is, in the permanent magnet type motor 100 of the present embodiment, electric current flows through the coil 30 of the stator 1 so as to intersect with the magnetic flux generated by the permanent magnet 50 of the rotor 2. When the magnetic flux of the permanent magnet 50 intersects with the electric current flowing through the coil 30, the permanent magnet type motor 10D of the present embodiment generates a driving force in the coil 30 in the circumferential direction by an electromagnetic action, thereby rotating the rotor 2 around the shaft 3.

In particular, as illustrated in FIGS. 2 to 5, the rotor 2 of the present embodiment has the rotor core blocks 41 in a multistage in the axial direction formed by incorporating the permanent magnets 50 of the plurality of magnetic poles, and has a multistage skew structure in which the rotor core blocks 41 of each stage are integrally formed so as to be shifted in the circumferential direction. The multistage skew structure is configured to reduce the rotary pulsation of the rotor 2, that is, the cogging torque.

However, in the multistage skew structure, the short circuit magnetic flux is likely to occur between the stages, and the short circuit magnetic flux becomes a factor of the torque decrease.

In the rotor 2 of the present embodiment, the rotor core blocks 41 of each stage have the flux barrier portions 60 for blocking the short circuit magnetic flux between the magnetic poles, between the magnetic poles of the permanent magnets 50. The flux barrier portions 60 of the present embodiment are dividedly formed as space portions on both sides of the permanent magnets 50 incorporated into the magnet insertion holes 42.

Moreover, in the rotor 2 of the present embodiment, in the rotor core blocks 41a and 41b of different stages, the skew angle is set so that the flux barrier portions 60a and 60b of the magnetic poles between the adjacent stages at least partially overlap each other. The cross-sectional shape of the flux barrier portions 60a and 60b which overlap each other has substantially an oval, and the outer peripheral shapes thereof substantially match each other.

In the present embodiment, in FIG. 5, the flux barrier portion 60a on the left side of the permanent magnet 50 in the rotor core block 41a of the first stage substantially match the flux barrier portion 60b on the right side of the permanent magnet 50 in the rotor core block 41b of the second stage in the axial direction. Even when the flux barrier portions 60a and 60b of only one side of the permanent magnet 50 match each other., since the flux barrier portions 60a and 60b are located between the magnetic poles, the short circuit magnetic flux between the stages is suppressed.

Thus, according to the rotor 2 of the present embodiment, it is possible to suppress the torque decrease associated with the occurrence of short circuit magnetic flux in the multistage skew structure, and it is possible to achieve a permanent magnet type motor 100 capable of effectively reducing the cogging torque.

### Second Embodiment

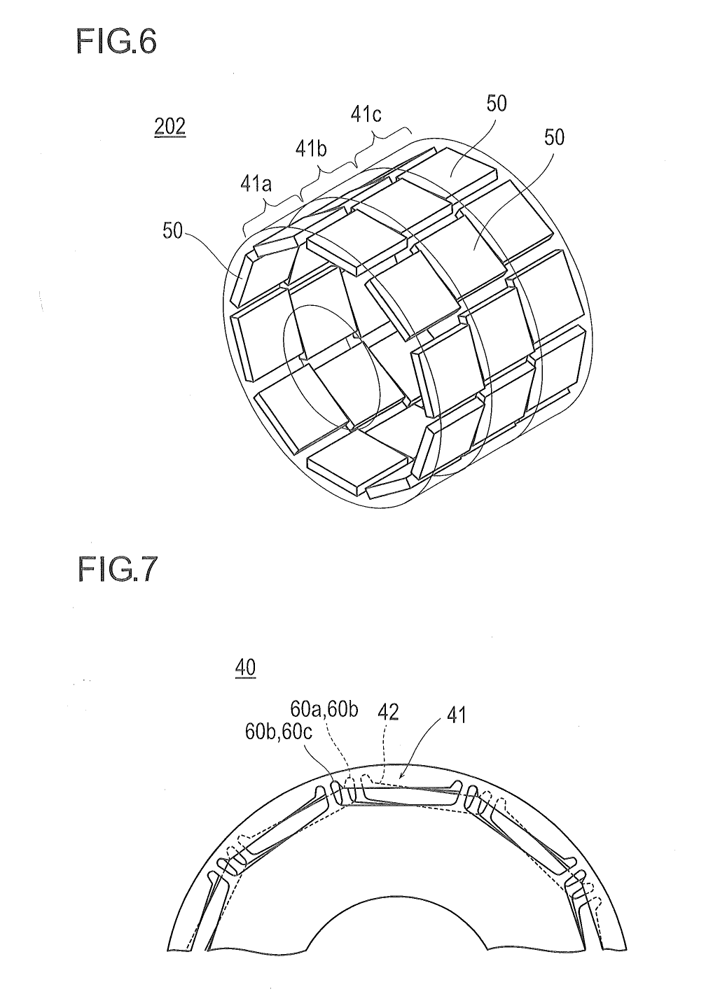

Next, a permanent magnet type motor according to a second embodiment will be described with reference to FIGS. 6 and 7. FIG. 6 is a perspective view of the rotor when a three-stage skew structure is provided in the same direction in the permanent magnet type rotor according to the second embodiment.

In FIG. 6, the rotor core is illustrated in a translucent manner so as to easily understand the state of the skew structure. FIG. 7 is an enlarged view of main parts when FIG. 6 is viewed from the axial direction. In FIG. 7, the front rotor core is illustrated in a translucent manner for clarity, and the permanent magnet is not illustrated. In addition, in FIGS. 6 and 7, the same components as those of the first embodiment will be described by denoting the same reference numerals.

As illustrated in FIG. 6, the second embodiment is different from the first embodiment in that the rotor 202 has a three-stage skew structure, and has a skew configuration in which the respective rotor core blocks 41 are shifted in the same direction.

Specifically, the rotor 202 of the second embodiment has the rotor core blocks 41a, 41b, and 41c of axial three stages formed by incorporating the permanent magnets 50 of the plurality of magnetic poles, and has a multistage skew structure in which the rotor core blocks 41a, 41b, and 41c of each stage are integrally formed in a state of being shifted in the same circumferential direction.

The respective cylindrical rotor core blocks 41a, 41b, and 41c are shifted in the same circumferential direction, but are formed in the same configuration. Accordingly, as illustrated in FIGS. 6 and 7, the magnet insertion holes 40 and the permanent magnets 50 incorporated into the magnet insertion holes 40 are disposed in a state of being shifted in order in the same direction.

The skew angle is set so that the flux barrier portions of the magnetic poles between the adjacent stages at least partially overlap each other in the rotor core blocks 41a, 41b, and 41c of different stages.

That is, in the rotor 202 of the present embodiment, as illustrated in FIG. 7, the skew angle is set so that the flux barrier portions 60a and 60b adjacent to each other overlap each other in the rotor core block 41a of the first stage and the rotor core block 41b of the second stage . Furthermore, the skew angle is set so that the flux barrier portions 60b and 60c adjacent to each other overlap each other in the rotor core block 41b of the second stage and the rotor core block 41c of the third stage.

In the rotor 202 of the present embodiment, the cross-sectional shape of the flux barrier portions 60a and 60b, or 60b and 60c which overlap each other is substantially an oval, and outer peripheral shapes thereof substantially match each other. Since the flux barrier portions 60a and 60b or 60b and 60c substantially match each other in the axial direction through the stage, it is possible to block the short circuit magnetic fluxes between the stages flowing in the axial direction, which makes it possible to suppress the torque reduction.

The second embodiment basically exhibits the same working effects as those of the first embodiment. In particular, in the permanent magnet type motor according to the second embodiment, the rotor 202 has a three-stage skew structure, and has a skew configuration in which and the respective rotor core blocks 41a, 41b, and 41c are shifted in the same direction. Therefore, the second embodiment also exhibits a particular effect that is able to effectively reduce the cogging torque by blocking the short circuit magnetic flux between the stages, in the permanent magnet type motor having the three-stage skew structure.

### Third Embodiment

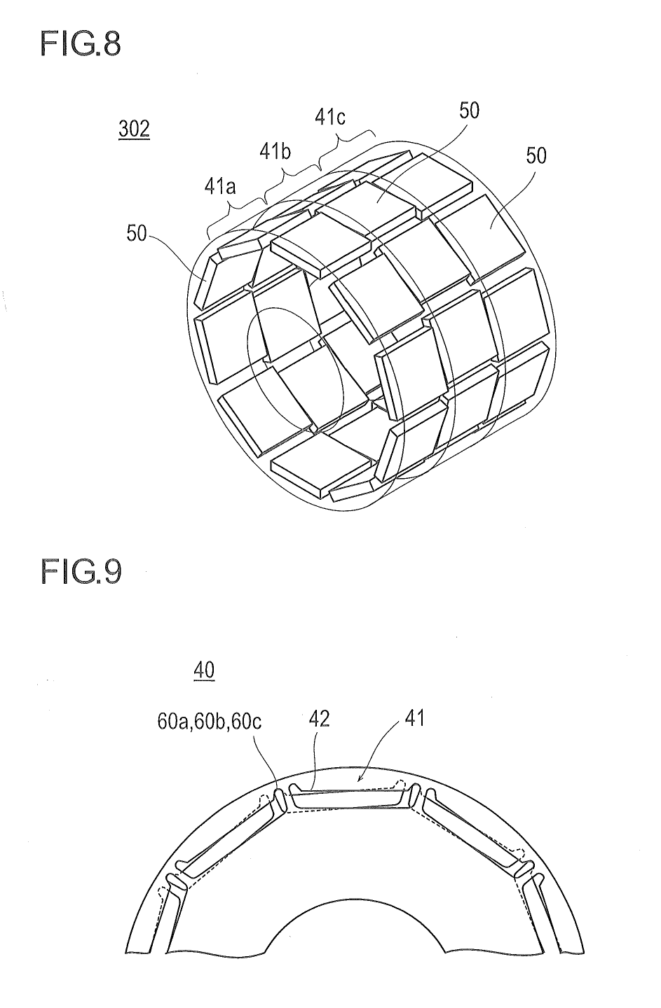

Next, a permanent magnet type motor according to a third embodiment will be described with reference to FIGS. 8 and 9. FIG. 8 is a perspective view of a rotor in a case in which a three-stage skew structure is provided and the skew directions are alternately inverted in the permanent magnet type rotor according to the third embodiment. In FIG. 8, the rotor core is illustrated in a translucent manner so as to easily understand the state of the skew configuration. FIG. 9 is an enlarged view of main parts when FIG. 8 is viewed from the axial direction. In FIG. 9, the front rotor core is illustrated in a translucent manner for clarity, and the permanent magnet is not illustrated. In FIGS. 8 and 9, the same components as those of the first embodiment will be described by denoting the same reference numerals.

As illustrated in FIG. 8, the third embodiment is different from the second embodiment in that the rotor 302 has a three-stage skew structure and the skew directions are alternately inverted.

Specifically, the rotor 302 according to the third embodiment has the rotor core blocks 41a, 41b, and 41c in three stages in the axial direction formed by incorporating the permanent magnets 50 of the plurality of magnetic poles, and has a stage skew structure in which the rotor core blocks 41a, 41b, and 41c of each stage are integrally formed in the state of alternately inverting and shifting the skew direction.

The respective cylindrical rotor core blocks 41a, 41b, and 41c alternately invert the skew direction, but are formed in the same configuration. Therefore, as illustrated in FIGS. 8 and 9, the magnet insertion holes 40 and the permanent magnets 50 incorporated into the magnet insertion holes 40 are disposed in a state of being alternately shifted in different directions.

The skew angle is set so that the flux barrier portions 60 of the magnetic poles between the adjacent stages at least partially overlap each other in the rotor core blocks 41a, 41b, and 41c of different stages.

That is, in the rotor 302 of the present embodiment, as illustrated in FIG. 9, the skew angle is set so that the adjacent flux barrier portions 60a, 60b, and 60c overlap one another in the rotor core block 41a of the first stage, the rotor core block 41b of the second stage, and the rotor core block 41c of the third stage.

In the rotor 302 of the present embodiment, the cross-sectional shape of the flux barrier portions 60a, 60b, and 60c which overlap one another is substantially an oval, and the outer peripheral shapes thereof substantially match. All the flux barrier portions 60a, 60b, and 60c from the first stage to the third stage overlap into one, and when viewed from the axial direction, twenty flux barriers become through holes. Accordingly, the rotor 302 of the present embodiment is able to more reliably block the short circuit magnetic flux between stages flowing in the axial direction, thereby further suppressing the torque reduction.

The third embodiment basically exhibits the same working effects as those of the second embodiment. In particular, in the permanent magnet type motor 300 according to the third embodiment, the rotor 302 has a three-stage skew structure, and the rotor core blocks 41a, 41b, and 41c are alternately inverted in the skew direction. As a result, all the flux barrier portions 60a, 60b, and 60c from the first stage to the third stage overlap into one, and when viewed in the axial direction, the flux barrier portions 60a, 60b, and 60c become through holes. Accordingly, the third embodiment has a particular effect that is able to more effectively reduce the cogging torque by reliably blocking the short circuit magnetic flux between the stages in the permanent magnet type motor including the three-stage rotor skew structure.

### Fourth Embodiment

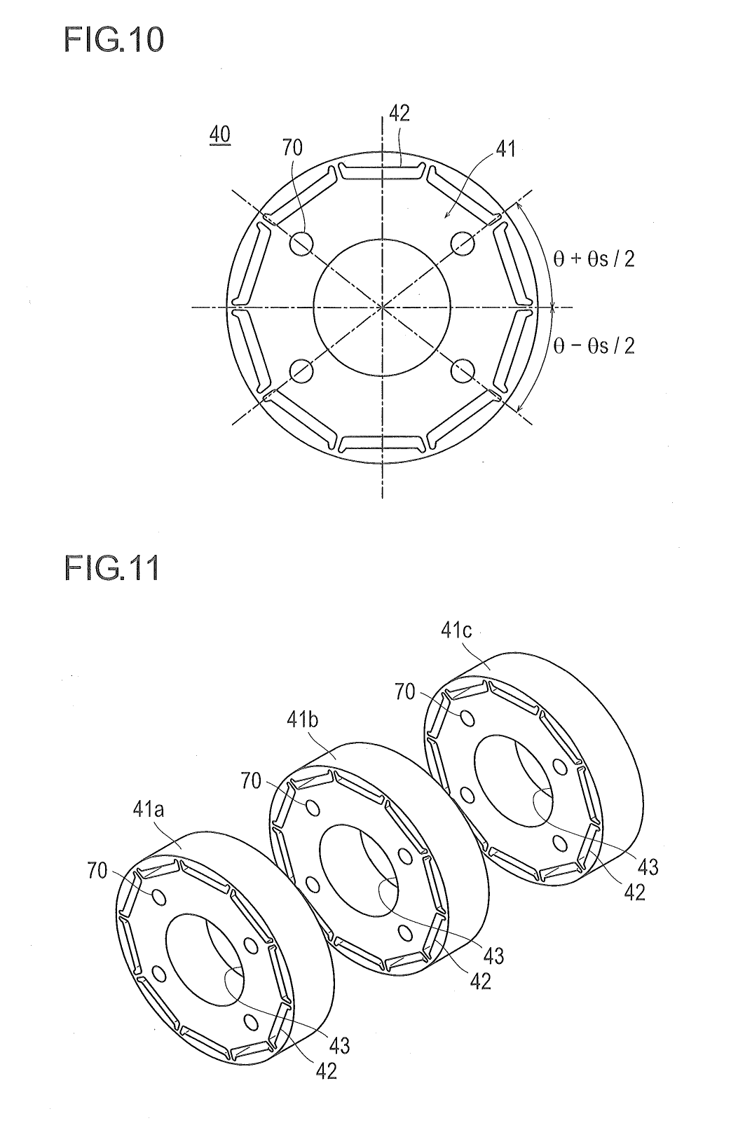

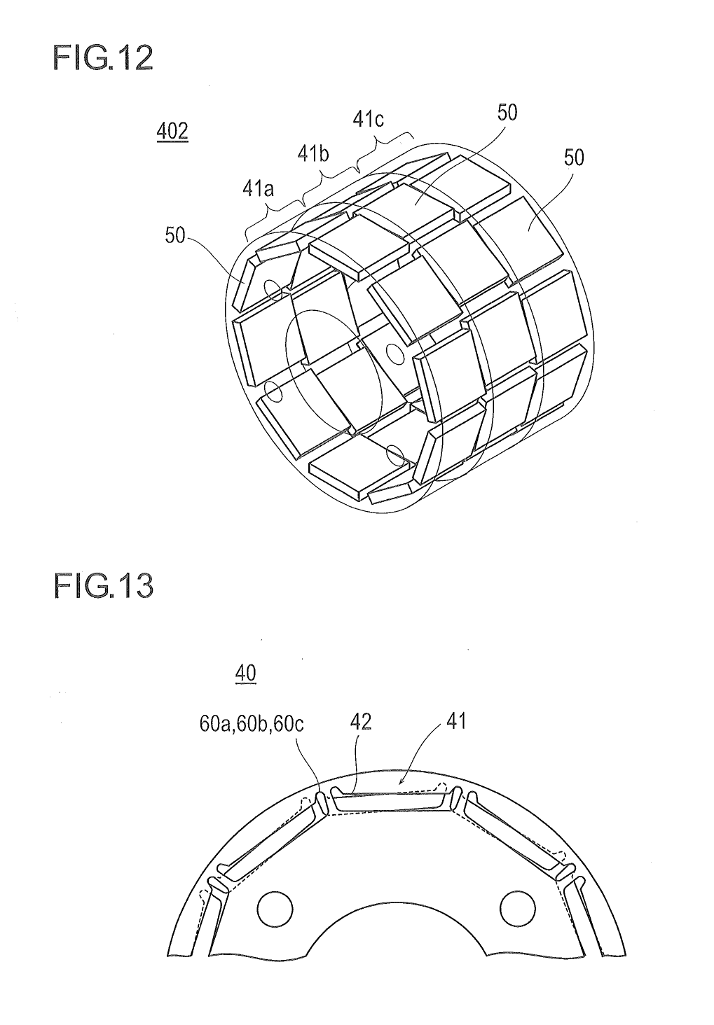

Next, a permanent magnet type motor according to a fourth embodiment will be described with reference to FIGS. 10 to 12. FIG. 10 is a schematic view of a rotor core having skew positioning holes in the permanent magnet type rotor according to the fourth embodiment. FIG. 11 is an exploded perspective view of the rotor having the skew positioning holes. FIG. 12 is a perspective view of the rotor in the case in which the three-stage skew structure is provided and the skew directions are alternately inverted in the permanent magnet type rotor according to the fourth embodiment.

FIG. 13 is an enlarged view of main parts when FIG. 12 is viewed from the axial direction. In FIG. 13, the front rotor core is illustrated in a translucent manner for clarity, and the permanent magnet is not illustrated. In addition, in FIGS. 10 to 12, the same components as those of the first embodiment will be described by denoting the same reference numerals.

As illustrated in FIG. 10, the fourth embodiment is different from the third embodiment in that a rotor 402 has a three-stage skew structure, and each of the rotor core blocks 41a, 41b, and 41c has the skew positioning hole 70.

The skew positioning holes 70 serve as a reference for configuring the multistage skew structure. More specifically, when the skew angle per a stage is assumed to be θs, the skew positioning hole 70 is set at a site in which the symmetry is shifted by ±θs/2° with respect to any symmetry center line based on the magnet insertion hole 42.

Furthermore, as illustrated in FIGS. 11 and 12, the rotor core blocks 41a, 41b, and 41c are positioned by alternately inverting the rotor core blocks 41a, 41b, and 41c of each stage so that the skew positioning holes 70 match around the central axis of the shaft fitting hole 43.

Moreover, by integrally forming the positioned rotor core blocks 41a, 41b, and 41c, the rotor core 40 is completed. The rotor 402 of the three-stage skew structure completed using the rotor core 40 has the same configuration as that of the rotor 302 of the third embodiment except the skew positioning holes 70 (see FIG. 8).

As illustrated in FIGS. 11 and 13, in the rotor 402 of the present embodiment, the adjacent flux barrier portions 60a, 60b, and 60c are set to overlap each other in the rotor core block 41a of the first stage, the rotor core block 41b of the second stage, and the rotor core block 41c of the third stage.

In the rotor 402 of the present embodiment, the cross-sectional shape of the adjacent flux barrier portions 60a, 60b, and 60c which overlap one another is substantially an oval, and the outer peripheral shapes thereof substantially match. All the flux barrier portions 60a, 60b, and 60c from the first stage to the third stage overlap into one, and when viewed in the axial direction, the twenty flux barriers become through holes. Similarly, the skew positioning holes 70 serve as four through holes. Accordingly, the rotor 402 of the present embodiment is able to more reliably block the short circuit magnetic flux between the stages flowing in the axial direction, thereby further suppressing the torque reduction.

The fourth embodiment basically has the same working effects as those of the third embodiment. In particular, since the fourth embodiment has the skew positioning holes 70 serving as a reference for configuring the multistage skew structure, there is a particular effect that is able to very easily configure a multistage skew structure.

Hereinbefore, although the preferred embodiments of the invention have been described, these embodiments are examples for the purpose of describing the invention, and it is not intended to limit the scope of the invention to only the above embodiments. The invention can be practiced in various aspects different from the above embodiments without departing from the gist of the invention.

For example, in the above embodiments, although the two-stage or three-stage skew structure has been described as an example, but it goes without saying that the invention may also be applied to the rotor of the skew structure of four or more stages and the permanent magnet type motor.

1. A rotor for a permanent magnet type motor having rotor core blocks in a multistage in an axial direction formed by incorporating permanent magnets of a plurality of magnetic poles, and having a multistage skew structure in which the rotor core blocks of each stage are integrally formed so as to be shifted from each other in a circumferential direction,
wherein the rotor core blocks of each stage have a flux barrier portion for blocking short circuit magnetic flux between the magnetic poles, between the magnetic poles of the permanent magnet, and
a skew angle is set so that the flux barrier portions of the magnetic poles between the adjacent stages at least partially overlap each other in the rotor core blocks of different stages.

2. The rotor for the permanent magnet type motor according to claim 1,
wherein the flux barrier portions of all stages at least partially match each other in the axial direction.

3. The rotor for the permanent magnet type motor according to claim 1,
wherein the flux barrier portions are dividedly formed as space portions on both sides of the permanent magnet.

4. The rotor for the permanent magnet type motor according to claim 3,
wherein a non-magnetic material is filled in the flux barrier portions.

5. The rotor for the permanent magnet type motor according to claim 1,
wherein each of the rotor core blocks has a skew positioning hole serving as a reference for configuring the multistage skew structure.

6. The rotor for the permanent magnet type motor according to claim 5,
wherein when the skew angle per stage is assumed to be θs, the skew positioning holes are set at a site in which the symmetry is shifted by ±θs/2° with respect to any symmetry center line based on magnet insertion holes into which the permanent magnets are incorporated.

7. A method of manufacturing a rotor for a permanent magnet type motor, the rotor having rotor core blocks in a multistage in an axial direction formed by incorporating permanent magnets of a plurality of magnetic poles, and having a stage skew structure in which the rotor core blocks of each stage are integrally formed so as to be shifted from each other in a circumferential direction,
wherein when a skew angle per stage is assumed to be Os, skew positioning holes are set at a site in which the symmetry is shifted by ±θs/2° with respect to any symmetry center line based on magnet insertion holes into which the permanent magnets are incorporated, and
the rotor cores of the multistage skew structure are integrally formed by alternately inverting the rotor core blocks of each stage so that the skew positioning holes match each other.

8. A permanent magnet type motor in which the rotor according to claim 1 is arranged in the interior of a stator having a plurality of coils.
